(19) United States
(12) Patent Application Publication
(10) Pub. No.: US 2024/0101287 A1
(43) Pub. Date: Mar. 28, 2024

(54) Transport System for Unmanned Aerial Vehicle

(71) Applicant: Daifuku Co., Ltd., Osaka-shi (JP)

(72) Inventors: Toyoki Takahashi, Komaki-shi (JP); Keisuke Takeno, Komaki-shi (JP); Satoshi Nitta, Komaki-shi (JP); Hidemoto Fukushima, Komaki-shi (JP)

(21) Appl. No.: 18/371,024

(22) Filed: Sep. 21, 2023

(30) Foreign Application Priority Data
Sep. 22, 2022 (JP) 2022-151085

(51) Int. Cl. B64U 80/10

(52) U.S. Cl. CPC B64U 80/10; B64U 2101/64

(57) ABSTRACT

A transport system for an unmanned aerial vehicle includes a control device that controls an unmanned aerial vehicle and a transport vehicle. The control device outputs a move command designating a destination of the unmanned aerial vehicle to both the transport vehicle and the unmanned aerial vehicle held by the transport vehicle. In response to receiving the move command, the transport vehicle travels to a corresponding stop position set on a travel route R in correspondence to the destination and stops at the corresponding stop position, and the unmanned aerial vehicle takes off from an aerial vehicle holding section and moves to the destination while the transport vehicle is stopped at the corresponding stop position.

### CROSS-REFERENCE TO RELATED APPLICATION

This application claims priority to Japanese Patent Application No. 2022-151085 filed Sep. 22, 2022, the disclosure of which is hereby incorporated by reference in its entirety.

### BACKGROUND OF THE INVENTION

### 1. Field of the Invention

The present invention relates to a transport system for an unmanned aerial vehicle.

### 2. Description of Related Art

Transport systems for unmanned aerial vehicles are known. JP 2021-20529A (Patent Document 1) discloses a transport system for unmanned aerial vehicles that transport articles.

The unmanned aerial vehicles of the transport system disclosed in Patent Document 1 fly along a commercial power line and are charged utilizing commercial power flowing through the power line. Movement of the unmanned aerial vehicles is thus interrupted during charging. In particular, the unmanned aerial vehicles need to be charged more frequently when transporting heavy articles. Also, if there are any indoor or outdoor no-fly zones, the unmanned aerial vehicles need to bypass those zones. As a result, there is a problem in that the efficiency with which articles and unmanned aerial vehicles are transported decreases.

### SUMMARY OF THE INVENTION

In view of the foregoing, it is desirable to realize a transport system having high transport efficiency.

A transport system according to the present disclosure includes an unmanned aerial vehicle, a transport vehicle configured to travel along a predetermined travel route and including an aerial vehicle holding section configured to hold the unmanned aerial vehicle, and a control device configured to control the unmanned aerial vehicle and the transport vehicle. The control device outputs a move command designating a destination of the unmanned aerial vehicle to both the transport vehicle and the unmanned aerial vehicle held by the transport vehicle. In response to receiving the move command, the transport vehicle travels to a corresponding stop position set on the travel route in correspondence to the destination and stops at the corresponding stop position, and the unmanned aerial vehicle takes off from the aerial vehicle holding section and moves to the destination while the transport vehicle is stopped at the corresponding stop position.

According to this configuration, an unmanned aerial vehicle can be transported by a transport vehicle to a corresponding stop position that corresponds to a destination, and the unmanned aerial vehicle is able to fly from the corresponding stop position to the destination. Thus, for example, when transporting a heavy object with an unmanned aerial vehicle and a transport vehicle, the flight distance and flight duration of the unmanned aerial vehicle can be reduced. Also, for example, a plurality of unmanned aerial vehicles can be collectively transported by a transport vehicle, or a transport vehicle can be used to move an unmanned aerial vehicle through a segment where unmanned aerial vehicles are unable to fly. Accordingly, the efficiency with which articles and unmanned aerial vehicles are transported can be increased. Also, even if there is a destination that is not set on the travel route, the destination can be reached with an unmanned aerial vehicle, and thus the travel route of the transport vehicle does not need to be provided in close proximity to every conceivable destination, thereby enabling the cost of installing the travel route to be reduced. Also, since the unmanned aerial vehicles take off while the transport vehicle is stopped at a corresponding stop position, unmanned aerial vehicles that fly automatically are facilitated in taking off with precision.

### BRIEF DESCRIPTION OF THE DRAWINGS

FIG. 1 shows a transport system for unmanned aerial vehicles according to a first embodiment.

FIG. 2 is a side view of unmanned aerial vehicles and a transport vehicle of FIG. 1.

FIG. 3 is the block diagram of the transport system in FIG. 1.

FIG. 4 is a flowchart of unmanned aerial vehicle transport processing by the transport system in FIG. 1.

FIG. 5 shows a transport system for unmanned aerial vehicles according to a second embodiment.

FIG. 6 is a flowchart of unmanned aerial vehicle transport processing by the transport system in FIG. 5.

### DESCRIPTION OF THE INVENTION

### First Embodiment

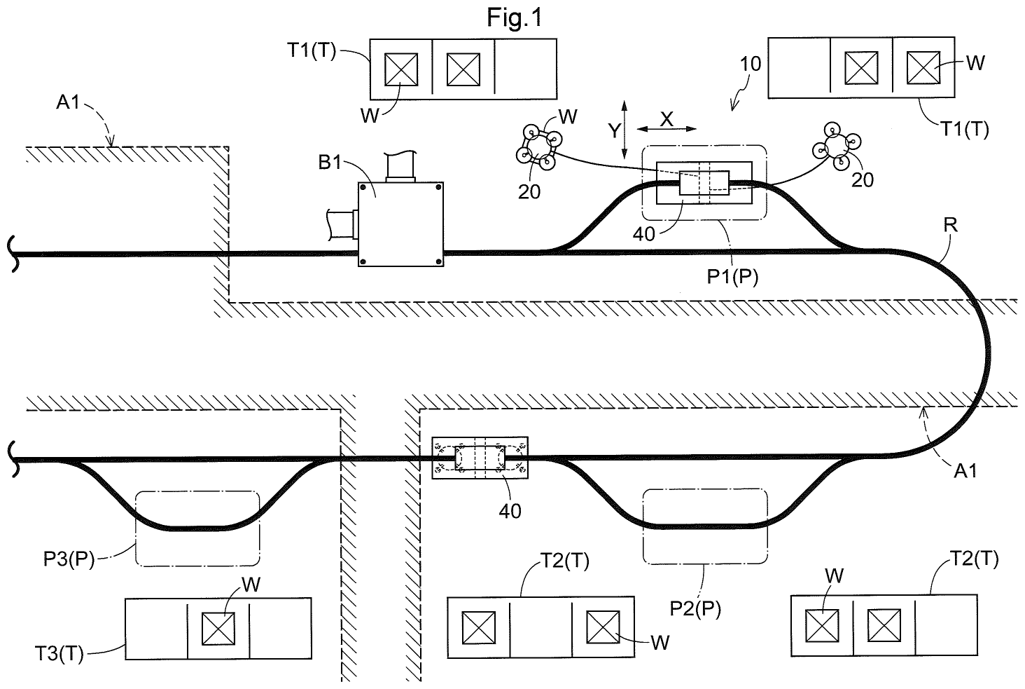

Hereinafter, a transport system 10 for an unmanned aerial vehicle 20 according to the present embodiment will be described with reference to the drawings. FIG. 1 illustrates the transport system 10 for the unmanned aerial vehicle 20 according to the present embodiment. The transport system 10 includes the unmanned aerial vehicle 20 and a transport vehicle 40 that travels along a predetermined travel route R. Here, the direction perpendicular to the page in FIG. 1 will be referred to as an up-down direction Z, the direction along the travel route R will be referred to as a travel direction X, and the direction orthogonal to the travel direction X when viewed in the up-down direction will be referred to as a width direction Y. In the present embodiment, the transport system 10 includes a plurality of unmanned aerial vehicles 20 and a plurality of transport vehicles 40. Note that the number of the unmanned aerial vehicles 20 and transport vehicles 40 included in the transport system 10 can both be set as appropriate. Also, in the present embodiment, the travel route R passes through a no-fly area A1 where the unmanned aerial vehicles 20 are prohibited from flying.

Examples of the unmanned aerial vehicle 20 include a fixed-wing aerial vehicle and a rotary-wing aerial vehicle that are capable of being remotely controlled or flying autonomously. In the present embodiment, the unmanned aerial vehicle 20 is an electric rotary-wing aerial vehicle capable of vertical takeoff and landing. Preferably, the unmanned aerial vehicle 20 is a multicopter (so-called drone) capable of flying autonomously. Also, preferably, the unmanned aerial vehicle 20 is a wired rotary-wing aerial vehicle that receives power supply from a power source section 63 provided in the transport vehicle 40 via a power supply line 62 described later. The unmanned aerial vehicle 20 picks up an article W from a destination T1 which is the pickup destination, and transports the article W to a destination T2 or a destination T3 which is the transport destination, for example.

Examples of the transport vehicle 40 include a rail guided vehicle configured to travel on a travel route R formed by rails installed on the floor or ceiling and an unmanned transport vehicle configured to travel on a travel route R through an indoor or outdoor passage and capable of being remotely controlled or traveling autonomously. In the present embodiment, the transport vehicle 40 is an overhead transport vehicle that travels along a travel route R installed indoors on a ceiling.

In the present embodiment, a corresponding stop position P, which is a stop position set in correspondence to a destination T, is set on the travel route R. Also, the corresponding stop position P is set in a location where the unmanned aerial vehicle 20 is not obstructed by an obstacle B1 when taking off from an aerial vehicle holding section 44. In the illustrated example, stop positions P1, P2 and P3 are corresponding stop positions P set in advance for respective destinations T1, T2 and T3. Also, the corresponding stop positions P are set in locations other than the no-fly area A1. Examples of the obstacle B1 include an exhaust duct or a tunnel. Preferably, the corresponding stop positions P are stop positions provided in double track segments of the travel route R. Adopting this configuration enables transport vehicles 40 to overtake other transport vehicles 40 that are stopped at the corresponding stop positions P.

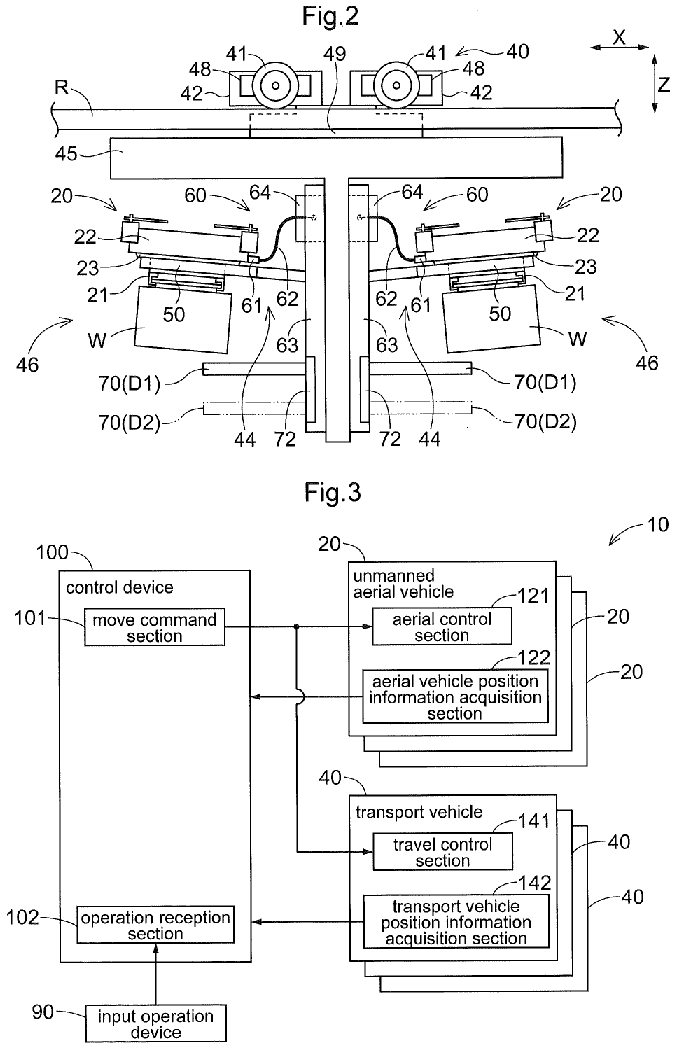

FIG. 2 shows side surfaces of unmanned aerial vehicles 20 and a transport vehicle 40. In the present embodiment, the unmanned aerial vehicles 20 each include an article holding section 21 capable of holding and releasing the article W. Also, the unmanned aerial vehicles 20 each include a main body 22 located upward of the article W held by the article holding section 21. The main body 22 is for realizing a flight function of the unmanned aerial vehicle 20. The main body 22 is provided with a mechanism for generating thrust and lift. The main body 22 includes a rotary wing and an electric motor that drives the rotary wing, for example. Also, the article holding section 21 holds the article W in a suspended state. Here, the state in which the unmanned aerial vehicle 20 is holding the article W with the article holding section 21 will be referred to as an article holding state, and the state in which the unmanned aerial vehicle 20 is not holding the article W with the article holding section 21 will be referred to as an article non-holding state.

In the present embodiment, the transport vehicles 40 each include the aerial vehicle holding section 44 that holds an unmanned aerial vehicle 20. The aerial vehicle holding section 44 is able to hold the unmanned aerial vehicle 20 regardless of whether the unmanned aerial vehicle 20 is in the article holding state or the article non-holding state, and allows the unmanned aerial vehicle 20 to take off and land in both the article holding state and the article non-holding state. In the illustrated example, the transport vehicle 40 includes a plurality of aerial vehicle holding sections 44 (two in FIG. 2).

In the present embodiment, the transport vehicles 40 each include a housing section 45 that houses the unmanned aerial vehicles 20 held by the aerial vehicle holding sections 44. This housing section 45 is disposed downward of a travel section 42. In the illustrated example, the housing section 45 includes, on both sides in the travel direction X and both sides in the width direction Y, openings 46 through which the unmanned aerial vehicles 20 pass when taking off and landing.

In the present embodiment, the aerial vehicle holding sections 44 of the transport vehicle 40 include, upward of the article W held by the article holding section 21, a support 50 that supports the main body 22 from below. In the present embodiment, as shown in FIG. 2, the support 50 is inclined in such a manner that the distal end side thereof, which is the side on which the unmanned aerial vehicle 20 exits during takeoff and enters during landing, is raised. Note that the support 50 may be a single insertion member or a pair of insertion members. Also, the support 50 may be a hanger from which the main body 22 of the unmanned aerial vehicle 20 is suspended.

In the present embodiment, the transport vehicle 40 includes the travel section 42 provided with a pair of wheels 41. Also, the travel section 42 of the transport vehicle 40 includes an electric motor 48 that drives the wheels 41. Also, the transport vehicle 40 includes a regenerative power recovery section 49 that recovers power obtained by performing regenerative braking of the electric motor 48 during deceleration of the travel section 42, and a power supply section 60 that supplies power to the unmanned aerial vehicles 20 held by the aerial vehicle holding sections 44. Power recovered by this regenerative power recovery section 49 is supplied to the unmanned aerial vehicles 20 from the power supply section 60. Also, in the present embodiment, the transport vehicle 40 includes the power supply line 62 provided with a connection section 61 connected to the unmanned aerial vehicles 20, the power source section 63 that supplies power to the unmanned aerial vehicles 20 via the power supply line 62, and a winding device 64 that takes up and feeds out the power supply line 62. The winding device 64 restricts the feed length of the power supply line 62 to a predetermined length. In this way, the unmanned aerial vehicles 20 can be constantly supplied with power by supplying power to the unmanned aerial vehicles 20 via the power supply line 62, and a long flight time of the unmanned aerial vehicles 20 can be ensured. In the illustrated example, the connection section 61, the power supply line 62, the power source section 63 and the winding device 64 constitute the power supply section 60.

In the present embodiment, the transport vehicle 40 includes a drop restricting member 70 that is disposed at a position downward of the article W held by the article holding section 21 and overlapping with the article W in the up-down direction, and that restricts the article W from dropping down. As shown in FIG. 2, the transport vehicle 40 includes a posture change mechanism 72 that changes the posture of the drop restricting member 70 between a restricting posture D1 in which the drop restricting member 70 restricts the article W held by the article holding section 21 of the unmanned aerial vehicle 20 from dropping down and a standby posture D2 in which the drop restricting member 70 does not interfere with the unmanned aerial vehicle 20 that is taking off and landing.

In the present embodiment, the posture change mechanism 72 changes the posture of the drop restricting member 70 between the restricting posture D1 and the standby posture D2 by moving the drop restricting member 70 in the up-down direction Z. Adopting this configuration facilitates restricting articles W that have different height dimensions from dropping down. Note that, in the example shown in FIG. 2, the drop restricting member 70 is spaced away from the article W in the restricting posture D1, but the drop restricting member 70 may come in contact with the article Win the restricting posture D1. Also, the posture of the drop restricting member 70 may be changed between the restricting posture D1 and the standby posture D2 by moving or turning in the horizontal direction, rather than moving in the up-down direction Z. The transport vehicle 40 may also include a holding member that sandwiches and holds side surfaces of the article W, in addition to or instead of the drop restricting member 70.

FIG. 3 is a block diagram of the transfer system 10. In the present embodiment, the transport system 10 includes a control device 100 that controls the unmanned aerial vehicles 20 and the transport vehicles 40. In the present embodiment, the control device 100 includes a computational processing device such as a CPU (Central Processing Unit) and a main storage device such as RAM (Random Access Memory) or ROM (Read Only Memory) that can be accessed by the computational processing device. The functions of the control device 100 are realized by cooperation between hardware provided in the control device 100 and a program that is executed on hardware such as the computational processing device. Specifically, the functions of the control device 100 are realized by the control device 100 executing a program stored in a storage device (such as the main storage device or a separately provided storage section). In other words, a program (e.g., transport control program) for causing a computer to realize the functions of the control device 100 is stored in a storage device accessible to the computer. This program is provided by a storage medium or via a communication network, for example. The provided program is then stored in the storage device accessible to the computer. In the present embodiment, the control device 100 (specifically, computational processing device provided in control device 100) functions as a “computer”. Preferably, the control device 100 is a higher-level control device installed in a control facility (not shown), but the control device 100 may be provided in the transport vehicles 40 or the unmanned aerial vehicles 20. Also, in the case where the control device 100 includes multiple pieces of hardware separated in such a manner as to be communicable with each other, some of the hardware may be provided in the unmanned aerial vehicles 20 or the transport vehicles 40, and the remaining hardware may be provided in the control facility (not shown).

In the present embodiment, the control device 100 includes a move command section 101 that outputs a move command to a plurality of unmanned aerial vehicles 20 and a plurality of transport vehicles 40. The move command section 101 designates, as the destination T in the move command, at least one of a pickup destination (e.g., destination T1) from which the article W is to be picked up and a transport destination (e.g., destination T2) to which the article W is to be transported.

In the present embodiment, the plurality of unmanned aerial vehicles 20 each include an aerial control section 121 that controls the unmanned aerial vehicle 20. The aerial control section 121 controls takeoff, flight and landing of the unmanned aerial vehicle 20. Also, the aerial control section 121 controls holding and release of the article W in the unmanned aerial vehicle 20. Also, in the present embodiment, the plurality of unmanned aerial vehicles 20 each include an aerial vehicle position information acquisition section 122 that acquires aerial vehicle position information which is position information of the unmanned aerial vehicle 20. The aerial vehicle position information acquisition section 122 acquires, as the aerial vehicle position information, coordinate information of the unmanned aerial vehicle 20, for example. Examples of the aerial vehicle position information include coordinate information obtained by means such as GPS (Global Positioning System), RTK (Realtime Kinematic) or processing of images captured by image capturing devices (not shown) provided in the unmanned aerial vehicles 20, the transport vehicles 40, a facility and the like.

In the present embodiment, the plurality of transport vehicles 40 each include a travel control section 141 that controls the transport vehicle 40. The travel control section 141 controls travel and stopping of the transport vehicle 40. Also, the travel control section 141 controls the posture change mechanism 72. Also, in the present embodiment, the plurality of transport vehicles 40 each include a transport vehicle position information acquisition section 142 that acquires transport vehicle position information which is position information of the transport vehicle 40. The transport vehicle position information acquisition section 142 acquires, for example, the coordinate information of the transport vehicle 40 as the transport vehicle position information. Examples of the transport vehicle position information include coordinate information obtained by means such as GPS, RTK or processing of images captured by image capturing devices (not shown) provided in the unmanned aerial vehicles 20, the transport vehicles 40, a facility and the like.

In the present embodiment, the control device 100 outputs, to both the transport vehicles 40 and the unmanned aerial vehicles 20 held by the transport vehicles 40, a first move command designating the destination T of the unmanned aerial vehicles 20. Also, the control device 100 designates, as the destination T in the first move command, at least one of the transport destination to which the article W is to be transported and the pickup destination from which the article W is to be picked up. In the example shown in FIG. 3, the control device 100 includes the move command section 101 which outputs the first move command to both the travel control section 141 provided in the transport vehicles 40 and the aerial control section 121 provided in the unmanned aerial vehicles 20.

In the present embodiment, the transport vehicle 40, in response to receiving the first move command, travels to the corresponding stop position P set on the travel route R in correspondence to the destination T, and stops at the corresponding stop position P. In the example shown in FIG. 3, the travel control section 141 of the transport vehicle 40 controls the transport vehicle 40 to travel to and stop at the corresponding stop position P. Also, the transport vehicle 40 remains stopped at the corresponding stop position P until the unmanned aerial vehicles 20 have returned from the destination T and landed on the aerial vehicle holding sections 44 of the transport vehicle 40. In the example shown in FIG. 3, the travel control section 141 of the transport vehicle 40 controls the transport vehicle 40 to remain stopped at the corresponding stop position P until the unmanned aerial vehicles 20 land on the aerial vehicle holding sections 44.

In the present embodiment, the unmanned aerial vehicles 20, in response to receiving the first move command, take off from the aerial vehicle holding sections 44 and move to the destination T, while the transport vehicle 40 is stopped at the corresponding stop position P. In the example shown in FIG. 3, the aerial control section 121 of the unmanned aerial vehicles 20 controls the unmanned aerial vehicles 20 to take off from the aerial vehicle holding sections 44 of the transport vehicle 40 that has stopped at the corresponding stop position P and move to the destination T.

In the present embodiment, the control device 100 includes an operation reception section 102 that receives operation inputs of an operator. Also, the control device 100 is switchable between an automatic mode for automatically setting the destination T in accordance with a predetermined program and a manual mode for controlling the unmanned aerial vehicles 20 and the transport vehicles 40 according to the operation inputs. The operation reception section 102 is capable of receiving, in a wireless or wired manner, operation inputs of the operator that have been converted into input signals by an input operation device 90 such as a mobile terminal, keyboard, microphone or smartphone. Also, the control device 100 is switchable between the automatic mode and the manual mode, based on the input signals from the input operation device 90.

In the automatic mode, the unmanned aerial vehicle 20 is prohibited from flying while the transport vehicle 40 is traveling. In the present embodiment, the transport system 10 includes a plurality of unmanned aerial vehicles 20, and the unmanned aerial vehicles 20 held by the aerial vehicle holding sections 44 of a transport vehicle 40 are prohibited from flying while the transport vehicle 40 is traveling. In the manual mode, the transport vehicle 40 travels according to operation inputs of the operator, and the unmanned aerial vehicles 20 fly according to operation inputs of the operator regardless of whether the transport vehicle 40 is traveling or stopped. Adopting this configuration enables the operator to operate both the transport vehicle 40 and the unmanned aerial vehicles 20, when in the manual mode. Accordingly, work can be performed to restore a transport vehicle 40 or an unmanned aerial vehicle 20 in which an anomaly has occurred, for example. Also, the unmanned aerial vehicles 20 can be used to perform tasks such as inspecting the upper sections of rails installed on the floor or ceiling for grime and misalignment, inspecting the environment inside factories, and inspecting fan filter units and ducts. Preferably, in the automatic mode, the unmanned aerial vehicles 20 are prohibited from flying while the transport vehicle 40 is stopped at a position other than a predetermined stop position (e.g., corresponding stop position P or target stop position Pm described later), and while the transport vehicle 40 is traveling, and, in the manual mode, the transport vehicle 40 travels according to operation inputs of the operator, and the unmanned aerial vehicles 20 fly according to operation inputs of the operator regardless of whether the position of the transport vehicle 40 while traveling or stopped is a position other than a predetermined stop position (e.g., corresponding stop position P or target stop position Pm described later).

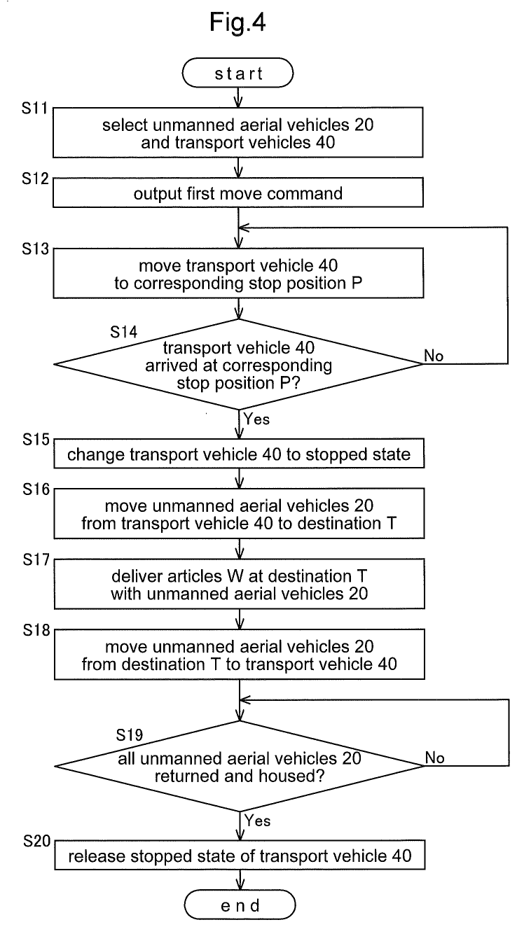

Hereinafter, unmanned aerial vehicle transport processing S10 for transporting unmanned aerial vehicles 20 will be described, with reference to the flowchart shown in FIG. 4.

In the present embodiment, the move command section 101 of the control device 100 executes transport vehicle selection processing S11 for selecting unmanned aerial vehicles 20 and transport vehicles 40 as the output destination of move commands. Next, the move command section 101 executes first move command output processing S12 for outputting a first move command designating the destination T of the unmanned aerial vehicles 20 to both the travel control section 141 provided in a selected transport vehicle 40 and the aerial control section 121 provided in the unmanned aerial vehicles 20 held by the transport vehicle 40.

The travel control section 141, in response to receiving the first move command, executes first travel control processing S13 for causing the transport vehicle 40 to travel to a corresponding stop position P set on the travel route R in correspondence to the destination T. Next, the travel control section 141 executes first arrival determination processing S14 for determining whether the transport vehicle 40 has arrived at the corresponding stop position P, based on the transport vehicle position information acquired by the transport vehicle position information acquisition section 142.

If the first arrival determination processing S14 is determined in the negative, the travel control section 141 of the transport vehicle 40 repeats the first travel control processing S13 and the first arrival determination processing S14.

If the first arrival determination processing S14 is determined in the affirmative, the travel control section 141 of the transport vehicle 40 executes first stop processing S15 for changing the transport vehicle 40 to a stopped state. Preferably, the stopped state is a travel prohibited state in which the transport vehicle 40 is prohibited from traveling.

Upon the transport vehicle 40 being changed to the stopped state in which the transport vehicle 40 is stopped at the corresponding stop position P, the aerial control section 121 of the unmanned aerial vehicles 20 executes move processing S16 for causing the unmanned aerial vehicles 20 to take off from the aerial vehicle holding sections 44 and move to the destination T. Upon the unmanned aerial vehicles 20 arriving at the destination T, the aerial control section 121 executes article delivery processing S17 for delivering the article W. Next, the aerial control section 121 executes return processing S18 for causing the unmanned aerial vehicles 20 to move and return to the transport vehicle 40.

Next, the travel control section 141 of the transport vehicle 40 performs return determination processing S19 for determining whether all the unmanned aerial vehicles 20 that took off in the move processing S16 have returned and are housed in the transport vehicle 40, based on the aerial vehicle position information acquired by the aerial vehicle position information acquisition section 122 of the unmanned aerial vehicles 20.

If the return determination processing S19 is determined in the negative, the travel control section 141 of the transport vehicle 40 repeats the return determination processing S19.

If the return determination processing S19 is determined in the affirmative, the travel control section 141 of the transport vehicle 40 executes travel preparation processing S20 for releasing the stopped state in order to allow the transport vehicle 40 to travel, and ends the unmanned aerial vehicle transfer processing S10. Preferably, the travel preparation processing S20 releases the travel prohibited state of the transport vehicle 40 and changes the transport vehicle 40 to a travel permitted state in which the transport vehicle 40 can move from the corresponding stop position P. Adopting this configuration facilitates the unmanned aerial vehicles 20 that fly automatically in returning from the destination T and landing with precision, since the transport vehicle 40 waits at the corresponding stop position P until the unmanned aerial vehicles 20 have returned from the destination T and landed on the aerial vehicle holding sections 44.

### Second Embodiment

Hereinafter, a transport system 10 for unmanned aerial vehicles 20 according to a second embodiment will be described with reference to the drawings. The present embodiment differs from the first embodiment in that the control device 100 selectively executes output of a first move command and output of a second move command and a third move command. The following description focuses on the differences from the first embodiment. Note that points that are not specifically described are similar to the first embodiment.

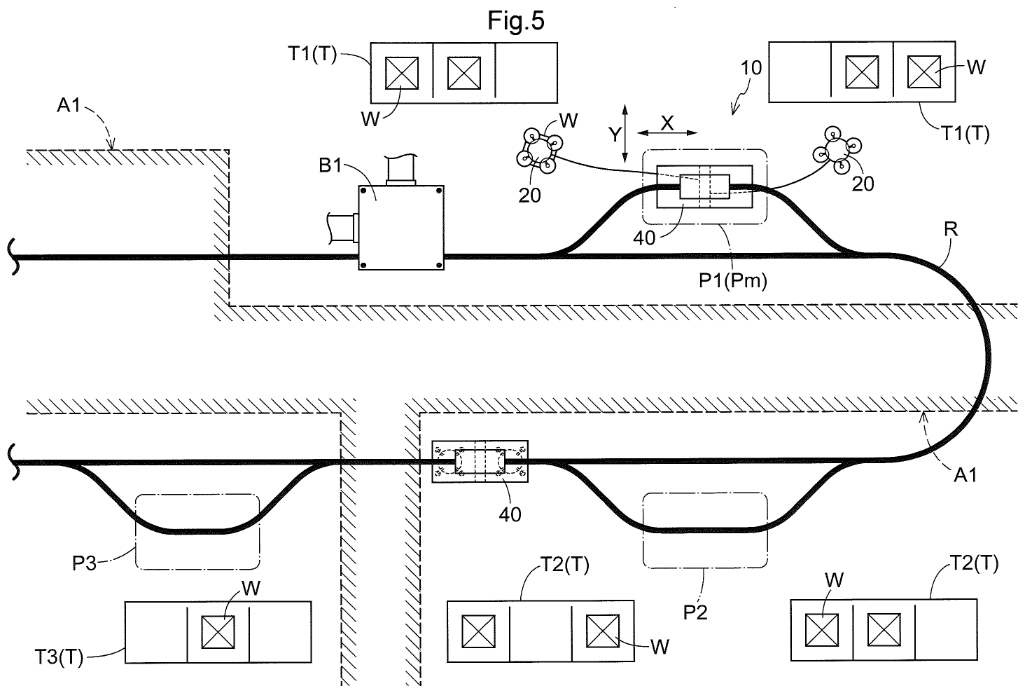

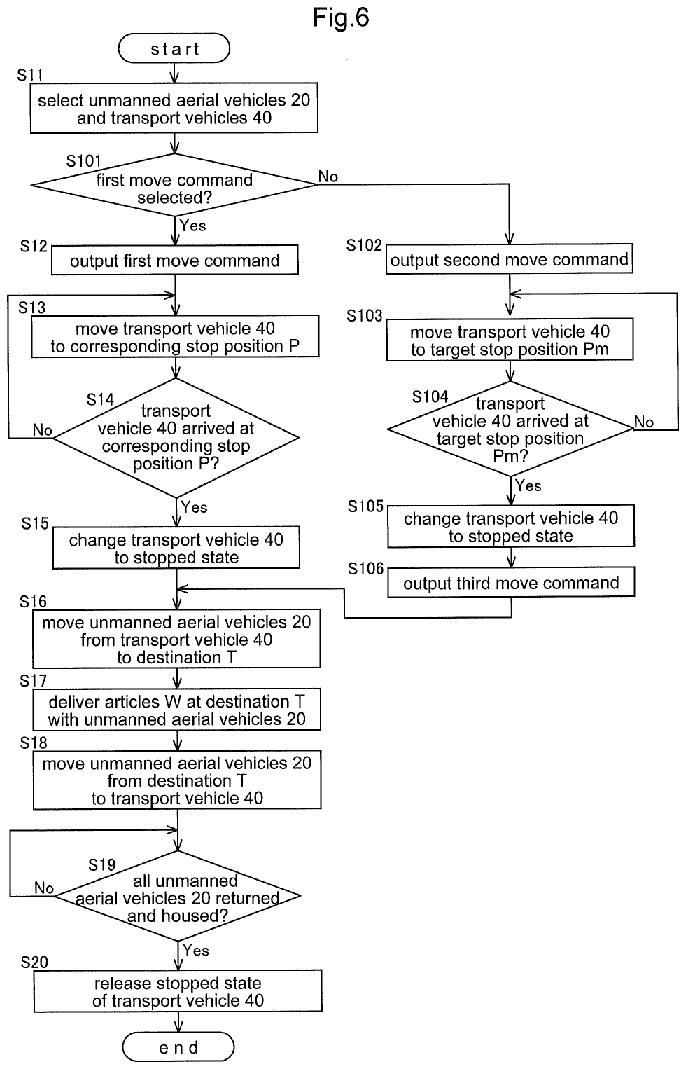

FIG. 5 illustrates the transport system 10 for the unmanned aerial vehicles 20 according to the present embodiment. FIG. 6 is a flowchart of unmanned aerial vehicle transport processing S10 in the present embodiment. In the present embodiment, stop positions P1, P2 and P3 need not be set in correspondence to respective destinations T1, T2 and T3. Also, in the example shown in FIG. 5, the stop position P1 is shown as the target stop position Pm of the transport vehicle 40, but the stop position P2 or the stop position P3 may be the target stop position Pm. In the present embodiment, the target stop position Pm is set in a location where the unmanned aerial vehicles 20 are not obstructed by an obstacle B1 when taking off from the aerial vehicle holding sections 44. Preferably, the target stop position Pm is a stop position provided in a double track segment of the travel route R.

In the present embodiment, the control device 100 selectively executes output of the first move command and output of the second move command and third move command. The second move command designates the target stop position Pm of the transport vehicles 40 that is set on the travel route R and is output to the transport vehicles 40. Also, the third move command designates the destination T of the unmanned aerial vehicles 20 and is output to the unmanned aerial vehicles 20. The control device 100 selects and executes output of the first move command when the destination T of the unmanned aerial vehicles 20 has been determined, and selects and executes output of the second move command and third move command when the target stop position Pm of the transport vehicle 40 has been determined but the destination T of the unmanned aerial vehicles 20 has yet to be determined.

In the present embodiment, in addition to being able to output the first move command described above, the control device 100 is able to output the second move command to the transport vehicle 40 and output the third move command to the unmanned aerial vehicles 20. The transport vehicle 40, in response to receiving the second move command, travels to the target stop position Pm and stops at the target stop position Pm.

In the present embodiment, the control device 100 outputs the second move command to the transport vehicle 40, and thereafter outputs the third move command to the unmanned aerial vehicles 20 held by the transport vehicle 40. The unmanned aerial vehicles 20, in response to receiving the third move command, take off from the aerial vehicle holding sections 44 and move to the destination T while the transport vehicle 40 is stopped at the target stop position Pm. For example, output of the third move command is executed after the second move command has been output and the transport vehicle 40 has started traveling to the target stop position Pm. The third move command may be output while the transport vehicle 40 is traveling, or may be output after the transport vehicle 40 has stopped at the target stop position Pm.

Hereinafter, the unmanned aerial vehicle transport processing S10 for transporting unmanned aerial vehicles 20 according to the present embodiment will be described, with reference to the flowchart shown in FIG. 6.

In the present embodiment, the move command section 101 of the control device 100 executes transport vehicle selection processing S11 for selecting unmanned aerial vehicles 20 and transport vehicles 40 as the output destination of move commands. Next, the move command section 101 executes command selection processing S101 for selecting one of output of the first move command and output of the second move command and third move command.

If output of the first move command is selected in the command selection processing S101, the control device 100 executes processing from the first move command output processing S12 to the travel preparation processing S20 described above, and ends the unmanned aerial vehicle transport processing S10.

If, in the command selection processing S101, output of the first move command is not selected, that is, if output of the second move command and third move command is selected, the move command section 101 executes second move command output processing S102 for outputting the second move command designating the target stop position Pm of the selected transport vehicle 40 to the travel control section 141 provided in the transport vehicle 40.

The travel control section 141, in response to receiving the second move command, executes second travel control processing S103 for causing the transport vehicle 40 to travel to the target stop position Pm of the transport vehicle 40 that is set on the travel route R. Next, the travel control section 141 executes second arrival determination processing S104 for determining whether the transport vehicle 40 has arrived at the target stop position Pm, based on the transport vehicle position information acquired by the transport vehicle position information acquisition section 142.

If the second arrival determination processing S104 is determined in the negative, the travel control section 141 of the transport vehicle 40 repeats the second travel control processing S103 and the second arrival determination processing S104.

If the second arrival determination processing S104 is determined in the affirmative, the travel control section 141 of the transport vehicle 40 executes second stop processing S105 for changing the transport vehicle 40 to a stopped state. Preferably, the stopped state is a travel prohibited state in which the transport vehicle 40 is prohibited from traveling.

Upon the transport vehicle 40 being changed to the stopped state in which the transport vehicle 40 is stopped at the target stop position Pm, the move command section 101 executes third move command output processing S106 for outputting, to the aerial control section 121 provided in the unmanned aerial vehicles 20 held in the selected transport vehicle 40, the third move command designating the destination T of the unmanned aerial vehicles 20. Upon the third move command being output, the control device 100 executes processing from the move processing S16 to the travel preparation processing S20 described above, and ends the unmanned aerial vehicle transport processing S10.

### Other Embodiments

Next, other embodiments of a transport system 10 for unmanned aerial vehicles 20 will be described.

(1) In the above embodiments, an example is described in which the unmanned aerial vehicles 20 are wired rotary-wing aerial vehicles. However, the disclosure is not limited to such an example, and, for example, the unmanned aerial vehicles 20 may not be provided with the connection section 61, the power supply line 62 and the winding device 64, and power may be supplied wirelessly to a storage battery provided in the unmanned aerial vehicles 20 from the power source section 63 of the transport vehicles 40.

(2) In the above embodiments, an example is described in which the unmanned aerial vehicles 20 are provided with the article holding section 21. However, the disclosure is not limited to such an example, and, for example, the unmanned aerial vehicles 20 may not transport the article W, and, for example, the transport vehicles 40 may transport unmanned aerial vehicles 20 for inspection.

(3) In the above embodiments, an example is described in which the transport vehicle 40 remains stopped at the corresponding stop position P or the target stop position Pm until all the unmanned aerial vehicles 20 are housed. However, the disclosure is not limited to such an example, and, for example, in the case where the unmanned aerial vehicles 20 land on aerial vehicle holding sections 44 external to the housing section 45, the transport vehicle 40 may remain stopped at the corresponding stop position P or the target stop position Pm until all the unmanned aerial vehicles 20 have returned and landed, and the unmanned aerial vehicles 20 may then be housed in the housing section 45 after the transport vehicle 40 has started traveling. Also, for example, the transport vehicle 40 may only remain stopped at the corresponding stop position P or the target stop position Pm until all wired unmanned aerial vehicles 20 have returned and landed.

(4) In the above embodiments, an example is described in which the transport vehicle 40 stops at the corresponding stop position P or the target stop position Pm until the unmanned aerial vehicles 20 have returned. However, the disclosure is not limited to such an example, and, for example, the transport vehicle 40 may move to a position other than the corresponding stop position P on the travel route R, and the unmanned aerial vehicles 20 may land at the position to which the transport vehicle 40 has moved. Also, for example, the transport vehicle 40 from which the unmanned aerial vehicles 20 take off may move away from the corresponding stop position P, and the unmanned aerial vehicles 20 may land on a different transport vehicle 40 that has stopped at the corresponding stop position P. Also, for example, the unmanned aerial vehicles 20 may land at the next corresponding stop position P, at the next target stop position Pm, at another facility, or on a slowly moving transport vehicle 40.

(5) In the above embodiments, an example is described in which the corresponding stop position P is set in advance for each destination T. However, the disclosure is not limited to such an example, and, for example, the corresponding stop position P may be set at a position on the travel route R that is closest to the destination T.

(6) In the above embodiments, an example is described in which the unmanned aerial vehicles 20 are provided with the aerial control section 121 and the aerial vehicle position information acquisition section 122, and the transport vehicles 40 are provided with the travel control section 141 and the transport vehicle position information acquisition section 142. However, the disclosure is not limited to such an example, and, for example, the control device 100 may be provided with the aerial vehicle control section 121 and the travel control section 141 and performs centralized control.

(7) In the above embodiments, an example is described in which the control device 100 is switchable between the automatic mode and the manual mode. However, the disclosure is not limited to such an example, and, for example, the control device 100 may be provided with only the automatic mode.

(8) In the above embodiments, an example is described in which the corresponding stop position P or the target stop position Pm is set in a location where the unmanned aerial vehicles 20 are not obstructed by an obstacle B1 when taking off from the aerial vehicle holding sections 44. However, the disclosure is not limited to such an example, and, for example, the unmanned aerial vehicles 20 may be transported by a transport device provided at the corresponding stop position P or the target stop position Pm to a position from which the unmanned aerial vehicles 20 can take off.

(9) In the second embodiment, an example is described in which the command selection processing S101 is performed after the transport vehicle selection processing S11. However, the disclosure is not limited to such an example, and, for example, unmanned aerial vehicles 20 and transport vehicles 40 may be selected in the transport vehicle selection processing S11, after the command selection processing S101 is performed. Also, for example, only transport vehicles 40 may be selected in the transport vehicle selection processing S11.

(10) In the second embodiment, an example is described in which the third move command output processing S106 is executed after the second stop processing S105. However, the disclosure is not limited to such an example, and, for example, the third move command output processing S106 may be executed after the second move command output processing S102 but before the second stop processing S105. Also, for example, the third move command output processing S106 may be executed at the same time as the second move command output processing S102.

(11) In the second embodiment, an example is described in which the control device 100 selects and executes output of the first move command when the destination T of the unmanned aerial vehicles 20 has been determined, and selects and executes output of the second move command and third move command when the destination T of the unmanned aerial vehicles 20 has yet to be determined. However, the disclosure is not limited to such an example, and, for example, the control device 100 may be provided with the operation reception section 102 that receives operation inputs of an operator, and may selectively execute output of the first move command and output of the second move command and third move command, based on the operation inputs of the operator. Also, for example, in the case where there are a plurality of destinations T of the unmanned aerial vehicles 20, travel of the transport vehicle 40 may be started by the second move command before determining the initial destination T.

(12) Note that the configurations disclosed in the above-described embodiments can also be applied in combination with the configurations disclosed in the other embodiments, provided there are no inconsistencies. With regard to other configurations, the embodiments disclosed herein are merely illustrative in all respects. Accordingly, various modifications can be made as appropriate, without departing from the spirit of the disclosure.

### Summary of the Embodiments

Hereinafter, the transport system for an unmanned aerial vehicle illustrated above will be described.

The transport system according to the present disclosure includes an unmanned aerial vehicle, a transport vehicle configured to travel along a predetermined travel route and including an aerial vehicle holding section configured to hold the unmanned aerial vehicle, and a control device configured to control the unmanned aerial vehicle and the transport vehicle. The control device outputs a move command designating a destination of the unmanned aerial vehicle to both the transport vehicle and the unmanned aerial vehicle held by the transport vehicle. In response to receiving the move command, the transport vehicle travels to a corresponding stop position set on the travel route in correspondence to the destination and stops at the corresponding stop position, and the unmanned aerial vehicle takes off from the aerial vehicle holding section and moves to the destination while the transport vehicle is stopped at the corresponding stop position.

According to this configuration, an unmanned aerial vehicle can be transported by a transport vehicle to a corresponding stop position that corresponds to a destination, and the unmanned aerial vehicle is able to fly from the corresponding stop position to the destination. Thus, for example, when transporting a heavy object with an unmanned aerial vehicle and a transport vehicle, the flight distance and flight duration of the unmanned aerial vehicle can be reduced. Also, for example, a plurality of unmanned aerial vehicles can be collectively transported by a transport vehicle, or a transport vehicle can be used to move an unmanned aerial vehicle through a segment where unmanned aerial vehicles are unable to fly. Accordingly, the efficiency with which articles and unmanned aerial vehicles are transported can be increased. Also, even if there is a destination that is not set on the travel route, the destination can be reached with an unmanned aerial vehicle, and thus the travel route of the transport vehicle does not need to be provided in close proximity to every conceivable destination, thereby enabling the cost of installing the travel route to be reduced. Also, since the unmanned aerial vehicles take off while the transport vehicle is stopped at a corresponding stop position, unmanned aerial vehicles that fly automatically are facilitated in taking off with precision.

As one mode, preferably the move command designating the destination of the unmanned aerial vehicle is a first move command, the control device selectively executes output of the first move command and output of a second move command and a third move command, the second move command designates a target stop position of the transport vehicle set on the travel route, and is output to the transport vehicle, the third move command designates the destination of the unmanned aerial vehicle and is output to the unmanned aerial vehicle, the control device outputs the second move command to the transport vehicle, and thereafter outputs the third move command to the unmanned aerial vehicle held by the transport vehicle, the transport vehicle, in response to receiving the second move command, travels to the target stop position and stops at the target stop position, and the unmanned aerial vehicle, in response to receiving the third move command, takes off from the aerial vehicle holding section and moves to the destination while the transport vehicle is stopped at the target stop position.

According to this configuration, an unmanned aerial vehicle can be transported to a target stop position by a transport vehicle, and, while the transport vehicle is traveling to the target stop position or while the transport vehicle is stopped at the target stop position, the control device is able to output a third move command designating a destination of the unmanned aerial vehicle. Thus, for example, even if the destination of an unmanned aerial vehicle or the transport destination of an article is not specifically determined, the transport vehicle is able to start traveling, and the efficiency with which unmanned aerial vehicles and articles are transported can be readily increased.

As one mode, preferably the transport vehicle remains stopped at the corresponding stop position until the unmanned aerial vehicle returns from the destination and lands on the aerial vehicle holding section.

According to this configuration, since the transport vehicle remains stopped at the corresponding stop position until the unmanned aerial vehicles return and land, unmanned aerial vehicles that fly automatically are facilitated in returning from the destination and landing with precision.

As one mode, preferably the unmanned aerial vehicle includes an article holding section configured to hold and release an article, and the control device designates, as the destination in the move command, at least one of a transport destination to which the article is to be transported and a pickup destination from which the article is to be picked up.

According to this configuration, since articles can be transported from a transport vehicle to a destination by an unmanned aerial vehicle, articles can also be transported to a destination that is off the travel route of the transport vehicle. Conversely, since the travel route of the transport vehicle does not need to be provided in close proximity to every conceivable destination, the cost of installing the travel route can be reduced, and the efficiency with which articles and unmanned aerial vehicles are transported by the transport vehicle can be improved. The unmanned aerial vehicle can then be transported to another location, by again being held in the transport vehicle after having transported the article to the destination.

As one mode, preferably the control device includes an operation reception section configured to receive an operation input of an operator, and is switchable between (i) an automatic mode for automatically setting the destination in accordance with a predetermined program and (ii) a manual mode for controlling the unmanned aerial vehicle and the transport vehicle according to the operation input. In the automatic mode, the unmanned aerial vehicle is prohibited from flying while the transport vehicle is traveling, and, in the manual mode, (i) the transport vehicle travels according to the operation input, and (ii) the unmanned aerial vehicle flies according to the operation input regardless of whether the transport vehicle is traveling or stopped.

According to this configuration, in the manual mode, the operator is able to operate both the transport vehicle and the unmanned aerial vehicle. Accordingly, for example, it is possible to restore a transport vehicle or unmanned aerial vehicle in which an anomaly has occurred or to carry out tasks such as inspection by causing an unmanned aerial vehicle to perform different operations from normal.

As one mode, preferably the corresponding stop position is set in a location where the unmanned aerial vehicle is not obstructed by an obstacle when taking off from the aerial vehicle holding section.

According to this configuration, unmanned aerial vehicles are able to appropriately take off.

What is claimed is:

1. A transport system for an unmanned aerial vehicle, comprising:
an unmanned aerial vehicle;
a transport vehicle configured to travel along a predetermined travel route and comprising an aerial vehicle holding section configured to hold the unmanned aerial vehicle; and
a control device configured to control the unmanned aerial vehicle and the transport vehicle, and
wherein:
the control device outputs a move command designating a destination of the unmanned aerial vehicle to both the transport vehicle and the unmanned aerial vehicle held by the transport vehicle,
the transport vehicle, in response to receiving the move command, travels to a corresponding stop position set on the travel route in correspondence to the destination and stops at the corresponding stop position, and
the unmanned aerial vehicle, in response to receiving the move command, takes off from the aerial vehicle holding section and moves to the destination, while the transport vehicle is stopped at the corresponding stop position.

2. The transport system for an unmanned aerial vehicle according to claim 1, wherein:
the move command designating the destination of the unmanned aerial vehicle is a first move command,
the control device selectively executes output of the first move command and output of a second move command and a third move command,
the second move command designates a target stop position of the transport vehicle set on the travel route, and is output to the transport vehicle,
the third move command designates the destination of the unmanned aerial vehicle and is output to the unmanned aerial vehicle,
the control device outputs the second move command to the transport vehicle, and thereafter outputs the third move command to the unmanned aerial vehicle held by the transport vehicle, and
the transport vehicle, in response to receiving the second move command, travels to the target stop position and stops at the target stop position, and
the unmanned aerial vehicle, in response to receiving the third move command, takes off from the aerial vehicle holding section and moves to the destination,
while the transport vehicle is stopped at the target stop position.

3. The transport system for an unmanned aerial vehicle according to claim 1,
wherein the transport vehicle remains stopped at the corresponding stop position until the unmanned aerial vehicle returns from the destination and lands on the aerial vehicle holding section.

4. The transport system for an unmanned aerial vehicle according to claim 1,
wherein the unmanned aerial vehicle comprises an article holding section configured to hold and release an article, and
wherein the control device designates, as the destination in the move command, at least one of a transport destination to which the article is to be transported and a pickup destination from which the article is to be picked up.

5. The transport system for an unmanned aerial vehicle according to claim 1, wherein:
the control device comprises an operation reception section configured to receive an operation input of an operator, and is switchable between (i) an automatic mode for automatically setting the destination in accordance with a predetermined program and (ii) a manual mode for controlling the unmanned aerial vehicle and the transport vehicle according to the operation input,
in the automatic mode, the unmanned aerial vehicle is prohibited from flying while the transport vehicle is traveling, and
in the manual mode, (i) the transport vehicle travels according to the operation input, and (ii) the unmanned aerial vehicle flies according to the operation input regardless of whether the transport vehicle is traveling or stopped.

6. The transport system for an unmanned aerial vehicle according to claim 1,
wherein the corresponding stop position is set in a location where the unmanned aerial vehicle is not obstructed by an obstacle when taking off from the aerial vehicle holding section.
